(19) United States
(12) Patent Application Publication
(10) Pub. No.: US 2019/0287703 A1
(43) Pub. Date: Sep. 19, 2019

(54) MAGNETORHEOLOGICAL FLUID

(71) Applicant: KURIMOTO, LTD., Osaka (JP)

(72) Inventors: Yuya UESHIMA, Osaka (JP); Shuichi AKAIWA, Osaka (JP)

(73) Assignee: KURIMOTO, LTD., Osaka (JP)

(21) Appl. No.: 16/318,659

(22) PCT Filed: Jul. 21, 2016
(86) PCT No.: PCT/JP2016/003414

§ 371 Date: Jan. 17, 2019

(51) Int. Cl. H01F 1/44

(52) U.S. Cl. CPC H01F 1/447; H01F 1/28

(57) ABSTRACT

Disclosed is a magnetorheological fluid including a fine particle mixture and a dispersion medium. The fine particle mixture includes first particles, second particles, and third particles. The first particles are magnetic particles having an average particle size greater than or equal to 1 μm and less than or equal to 30 μm. The second particles are magnetic particles having an average particle size greater than or equal to 100 nm and less than or equal to 300 nm. The third particles are particles having an average particle size greater than or equal to 10 nm and less than or equal to 50 nm. A proportion of the first particles in the fine particle mixture is greater than or equal to 60 mass % and less than 99 mass %, the remainder being the second particles and the third particles.

### TECHNICAL FIELD

The present disclosure relates to magnetorheological fluids.

### BACKGROUND ART

A magnetorheological (MR) fluid is a type of fluid in which magnetic particles of, e.g., iron (Fe) are dispersed in a dispersion medium such as oil. Under no influence of a magnetic field, magnetic particles in the MR fluid are suspended randomly in the dispersion medium. In the presence of an externally applied magnetic field to the MR fluid, the magnetic particles form a large number of clusters along the direction of the magnetic field, and the yield stress increases. Thus, the MR fluid is a material whose rheological properties or mechanical properties can be easily controlled by using an electrical signal, and thus, application of the MR fluid to various fields has been studied. The MR fluid is currently principally used for direct drive devices such as shock absorbers for automobiles and seat dampers for construction machinery. Application to uses such as clutches and brakes has also been studied.

A magnetic fluid is another type of fluid in which magnetic particles are dispersed in a dispersion medium such as oil, as well as an MR fluid. Magnetic particles for use in the magnetic fluid have particle sizes of about several nanometers to 10 nm, and are caused to vibrate by Brownian motion resulting from thermal energy. Thus, magnetic particles do not form clusters even in the presence of an applied magnetic field to the magnetic fluid and the yield stress does not increase. In this aspect, the magnetic fluid completely differs from the MR fluid.

Magnetic particles typically used in an MR fluid have an average particle size of several micrometers to several tens of micrometers. The MR fluid uses magnetic particles larger than those used in the magnetic fluid, and clusters can be formed in the presence of an applied magnetic field. The MR fluid uses larger magnetic particles, and thus when it is left untreated, caking occurs due to sedimentation of magnetic particles. In addition, repetitive application and cancel of a magnetic field causes secondary agglomeration of magnetic particles, resulting in failure of maintenance of a stable dispersion state. To improve the stability of the MR fluid, MR fluids in which two kinds of magnetic particles having different particle sizes are mixed together have been studied (see, e.g., Patent Document 1 and Patent Document 2).

In Patent Document 1, larger diameter carbonyl ion particles and smaller diameter chromium dioxide particles are mixed together, for example. The chromium dioxide particles are adsorbed to the carbonyl ion particles, thereby attempting to achieve a stable MR fluid.

In Patent Document 2, a small amount of smaller diameter iron particles are mixed with larger diameter carbonyl iron particles. With this composition, stabilization of an MR fluid is attempted.

### CITATION LIST

### Patent Document

PATENT DOCUMENT 1: Japanese Unexamined Patent Publication (Japanese Translation of PCT Application) No. H07-507978

PATENT DOCUMENT 2: WO2012/120842

### SUMMARY OF THE INVENTION

### Technical Problem

However, even in the MR fluid in which two kinds of particles are mixed together, the uniformity of concentration distribution is insufficient, and when a prepared magnetorheological fluid is stored in a container and is then separated to manufacture a plurality of devices, the amounts of the particles supplied to the respective devices are nonuniform, and individual differences occur in device performance. To eliminate the individual differences of devices, the magnetorheological fluid within the container may be sufficiently stirred every time immediately before the magnetorheological fluid is supplied to devices, but that is impracticable in view of production efficiency.

The present disclosure attempts to provide a magnetorheological fluid that is high in the uniformity of concentration distribution and is easily supplied to devices.

### Solution to the Problem

An aspect of a magnetorheological fluid of the present disclosure includes: a fine particle mixture; and a dispersion medium in which the fine particle mixture is dispersed, wherein the fine particle mixture includes first particles, second particles, and third particles, the first particles are magnetic particles having an average particle size greater than or equal to 1 μm and less than or equal to 30 μm, the second particles are magnetic particles having an average particle size greater than or equal to 100 nm and less than or equal to 300 nm, the third particles are particles having an average particle size greater than or equal to 10 nm and less than or equal to 50 nm, and a proportion of the first particles in the fine particle mixture is greater than or equal to 60 mass % and less than 99 mass %, the remainder being the second particles and the third particles.

In an aspect of the magnetorheological fluid, the mass ratio of the third particles to the second particles may be greater than or equal to 0.1 mass % and less than or equal to 10 mass %.

In an aspect of the magnetorheological fluid, the third particles may be magnetite particles.

In an aspect of the magnetorheological fluid, at least one of the first particles, the second particles, or the third particles may have a surface modified layer provided on surfaces thereof, and a surface of the surface modified layer may be more hydrophobic than the surfaces of the at least one of the first particles, the second particles, or the third particles on which the surface modified layer is provided.

In an aspect of the magnetorheological fluid, at least one of the first particles, the second particles, or the third particles may have a surface modified layer provided on surfaces thereof, and a surface of the surface modified layer may be more hydrophilic than the surfaces of the at least one of the first particles, the second particles, or the third particles on which the surface modified layer is provided.

### Advantages of the Invention

An example magnetorheological (MR) fluid according to the present disclosure is high in the uniformity of concentration distribution and can be easily supplied to devices.

### BRIEF DESCRIPTION OF THE DRAWINGS

FIG. 1 is a cross-sectional view illustrating an example of a clutch using an MR fluid according to an embodiment.

FIG. 2 is a block diagram illustrating a system for producing metal particles used in the embodiment.

FIG. 3 is an electron micrograph of an MR fluid of Example 5.

FIG. 4 is an electron micrograph of an MR fluid of Comparative Example 1.

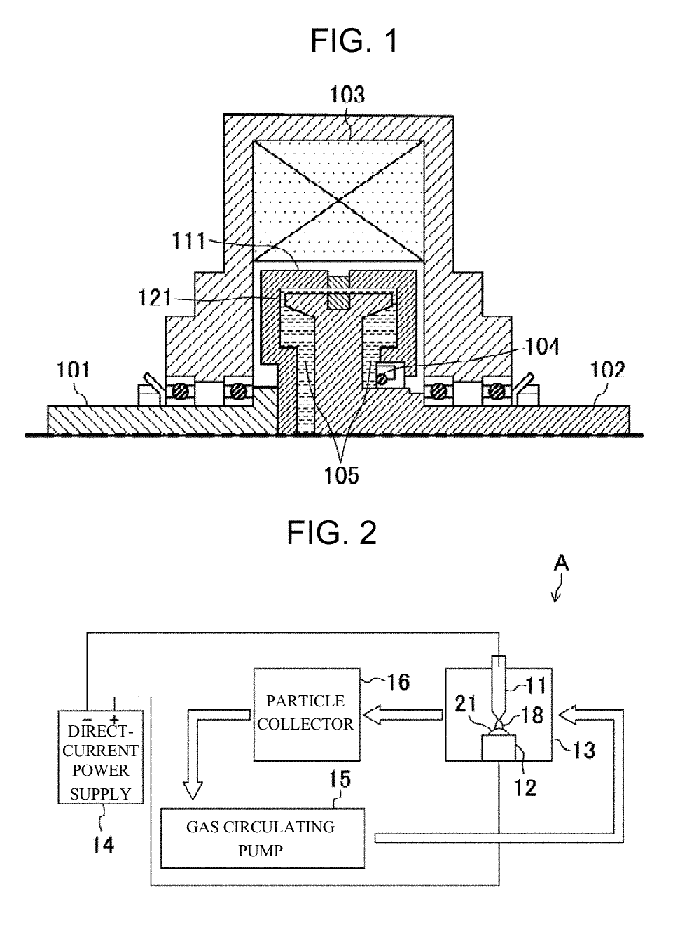

### DESCRIPTION OF EMBODIMENTS

A magnetorheological (MR) fluid of the present embodiment includes a fine particle mixture and a dispersion medium in which the fine particle mixture is dispersed. The fine particle mixture includes first particles, second particles, and third particles. The first particles are magnetic particles having an average particle size greater than or equal to 1 μm and less than or equal to 30 μm. The second particles are magnetic particles having an average particle size greater than or equal to 100 nm and less than or equal to 300 nm. The third particles are particles having an average particle size greater than or equal to 10 nm and less than or equal to 50 nm. A proportion of the first particles in the fine particle mixture is greater than or equal to 60 mass % and less than 99 mass %, and the second particles and the third particles are included in the fine particle mixture as the remainder.

For the first particles, magnetic particles for use in general MR fluids may be used. Specifically, in order to satisfy various characteristics required as a magnetorheological fluid, magnetic particles that may be used have an average particle size greater than or equal to 1 μm, preferably greater than or equal to 5 μm and less than or equal to 50 μm, preferably less than or equal to 30 μm, and more preferably less than or equal to 10 μm.

The first particles may be made of any material as long as the magnetic particles have an appropriate average particle size, and may be made of iron, iron nitride, iron carbide, carbonyl iron, chromium dioxide, low-carbon steel, nickel, or cobalt, for example. The first particles may also be made of an iron alloy such as an aluminium-containing iron alloy, a silicon-containing iron alloy, a cobalt-containing iron alloy, a nickel-containing iron alloy, a vanadium-containing iron alloy, a molybdenum-containing iron alloy, a chromium-containing iron alloy, a tungsten-containing iron alloy, a manganese-containing iron alloy, or a copper-containing iron alloy. Paramagnetic, superparamagnetic, or ferromagnetic compound particles of gadolinium or an organic derivative of gadolinium or particles of a mixture thereof may also be used. Among them, carbonyl iron is preferable because particles having an average particle size suitable for the first particles are easily obtained.

For the second particles, magnetic particles having an average particle size smaller than that of the first particles may be used. Specifically, in order to favorably provide cluster formation in the presence of an applied magnetic field, magnetic particles that may be used have an average particle size greater than or equal to 80 nm and preferably greater than or equal to 120 nm, and less than or equal to 300 nm and preferably less than or equal to 200 nm. The second particles preferably have as narrow particle size distribution as possible.

The second particles may be magnetic particles having an appropriate average particle size, and magnetic particles similar to the first particles may be used. Iron particles produced by an arc plasma process are preferable because the iron particles can be easily formed to have an average particle size appropriate for the second magnetic particles. In addition, particles of magnetite, which is a complex oxide including divalent iron and trivalent iron, are preferable because magnetite particles can be easily formed to have an average particle size appropriate for the second magnetic particles.

The second particles are preferably particles made of a soft magnetic material, which is magnetized in the presence of an applied magnetic field and is not substantially magnetized in the absence of an applied magnetic field. Specifically, the second particles are preferably particles having a coercive force less than or equal to 300 Oe, more preferably particles having a coercive force of less than or equal to 250 Oe, and further preferably particles having a coercive force of less than or equal to 200 Oe.

For the third particles, particles having an average particle size smaller than that of the second particles may be used. Specifically, in order to improve the uniformity of the concentration distribution of the magnetorheological fluid, particles that may be used have an average particle size greater than or equal to 10 nm and preferably greater than or equal to 20 nm, and less than or equal to 50 nm and preferably less than or equal to 40 nm. The third particles are preferably particles having a smaller particle size and a larger specific surface area.

The third particles may be magnetic particles, and nonmagnetic particles made of, e.g., silica or zirconia may also be used. The third particles are magnetic particles, whereby a change in magnetic permeability caused by its addition can be reduced. When the third particles are magnetic particles, for example, iron particles produced by an arc plasma process or magnetite may be used. These particles are preferable because particles having an average particle size suitable for the third magnetic particles are easily obtained.

Iron particles produced by an arc plasma process generally have an oxide film with a thickness of about 2 nm to 10 nm on their surfaces, and even particles with an average particle size less than or equal to 50 nm can be present stably in the air. Particles having an average particle size greater than or equal to 100 nm also have an oxide film with a thickness of about 2 nm to 10 nm on their surfaces.

The shape of the first particles, the second particles, and the third particles, which is not limited to a particular shape, is preferably a spherical shape. The spherical shape includes not only a perfect sphere but also spheroids having a major axis to minor axis ratio of about less than or equal to 1.4 and preferably less than or equal to 1.2 and other substantially spherical shapes. The shapes of the first particles, the second particles, and the third particles are a spherical shape, whereby the anisotropy of magnetic permeability can be reduced.

The proportion of the first particles in the fine particle mixture has an influence on, e.g., the magnitude of a viscosity change in the presence of an applied magnetic field. Given these circumstances, the proportion of the first particles in the fine particle mixture is greater than or equal to 60 mass % and preferably greater than or equal to 70 mass % in view of ensuring required characteristics as a magnetorheological fluid, and is less than 99 mass %, preferably less than or equal to 95 mass %, and more preferably less than or equal to 90 mass % in view of improving the uniformity of concentration distribution. The remainder of the fine particle mixture may be the second particles and the third particles.

In the fine particle mixture, the mass ratio (m₃/m₂) of the third particles to the second particles is preferably greater than or equal to 0.01, more preferably greater than or equal to 0.1, further preferably greater than or equal to 1, and even more preferably greater than or equal to 2, and preferably less than or equal to 12, more preferably less than or equal to 10, and further preferably less than or equal to 9.

The third particles, which are included even in a slight amount, are dispersed throughout the fluid and can improve the uniformity of concentration distribution; the proportion of the third particles in the fine particle mixture is preferably greater than or equal to 0.01 mass %, more preferably greater than or equal to 0.1 mass %, and further preferably greater than or equal to 1 mass %. The upper limit of the proportion of the third particles in the fine particle mixture, which depends on the proportions of the first particles and the second particles therein, is preferably less than or equal to 30 mass %, more preferably less than or equal to 20 mass %, and further preferably less than or equal to 10 mass % in view of ensuring required characteristics as a magnetorheological fluid.

The remainder of the fine particle mixture other than the first particles and the third particles may be the second particles. The proportion of the second particles in the fine particle mixture has an influence on, e.g., a viscosity change in a high shear rate range, sedimentation characteristics, and magnetic permeability. Given these circumstances, in view of ensuring required characteristics as a magnetorheological fluid, the proportion of the second particles in the fine particle mixture is preferably greater than or equal to 0.5 mass % and more preferably greater than or equal to 1.0 mass %. The upper limit of the proportion of the second particles in the fine particle mixture, which depends on the proportions of the first particles and the second particles therein, is preferably less than or equal to 30 mass %, more preferably less than or equal to 20 mass %, and even more preferably less than or equal to 10 mass %.

At least one of the first particles, the second particles, or the third particles may have a surface modified layer. The surface modified layer is provided on the surfaces of the particles, whereby affinity to the dispersion medium can be improved. The surface modified layer may be provided as needed and is not necessarily provided. When the surface modified layer is provided, it may be uniformly provided on the surface of each particle or may be provided on part of the surface of the particle.

When the dispersion medium is made of a hydrophobic material such as silicone oil, the surface modified layer being higher in hydrophobicity (oleophilicity) than surfaces of the particles themselves is preferably provided. To increase hydrophobicity, a hydrophobic compound as the surface modified layer may be immobilized to surfaces of the magnetic particles themselves. Examples of the hydrophobic compound include compounds having a straight chain or branched hydrocarbon chain or an aryl group. For the immobilization of the compound, various methods may be used; a hydroxy group may be introduced to the surfaces of the magnetic particles themselves, and a compound having a functional group that reacts with the hydroxy group may be bonded, for example. The hydroxy group introduced to the surfaces of the magnetic particles themselves and the compound may be bonded to each other via a bifunctional coupling agent.

When the dispersion medium is made of, e.g., water, the surface modified layer being higher in hydrophilicity than the surfaces of the particles themselves is preferably provided. To increase hydrophilicity, a hydroxy group may be introduced to the surfaces of the particles, for example. Alternatively, a hydrophilic compound may be introduced to the surfaces of the magnetic particles themselves using, e.g., a silane coupling agent.

The first particles, the second particles, and the third particles have the same kind of surface modified layer, thereby significantly reducing a torque in a high shearing speed region. This reduction may be caused by improvement in the affinity among the particles as well as improvement in the affinity between the particles and the dispersion medium. Alternatively, one or two of the first particles, the second particles, or the third particles may have a different kind of surface modified layer from the other/others has/have.

The dispersion medium may be any type of liquid as long as the fine particle mixture can be dispersed therein. For example, silicone oil, fluorine oil, polyalphaolefin (PAO), paraffin, ether oil, ester oil, mineral oil, vegetable oil, or animal oil may be used. Alternatively, an organic solvent such as toluene, xylene, hexane, or ethers or ionic liquid (room temperature molten salt) typified by ethylmethylimidazolium salt, 1-butyl-3-methylimidazolium salt, or 1-methylpyrazolium salt may be used, for example. These materials may be used alone or two or more of them may be used in combination. When a hydrophilic surface modified layer is provided, for example, water, esters, or alcohols may be used as the dispersion medium.

The concentration (volume fraction) of the fine particle mixture in the dispersion medium is preferably greater than or equal to 15 vol % in view of achieving an MR fluid. In view of reducing the base viscosity of the MR fluid, the concentration of the fine particle mixture in the dispersion medium is preferably less than or equal to 50 vol % and more preferably less than or equal to 30 vol %.

The first particles, the second particles, the third particles, and the dispersion medium are preferably mixed together with, for example, a spatula, and then subjected to full high-shear mixing with, for example, a planetary centrifugal mixer. Alternatively, after first dispersing any one or two of the particles in the dispersion medium, the residual particles may be dispersed in the dispersion medium successively or in combination. Instead of the mixer, for example, a homogenizer or a planetary mixer may be used to disperse magnetic particles. The magnetic particles may be dispersed by adding a dispersing agent, for example. When the affinity with the dispersion medium is improved by providing the particles with the surface modified layer, high-shear mixing is not necessarily performed.

In view of high uniformity of concentration distribution and reducing variations in the particle concentration of MR fluid separately supplied from a storage container, favorable thixotropic properties are required. Specifically, a thixotropy index (TI) is preferably greater than or equal to 2 and more preferably greater than or equal to 3, and preferably less than or equal to 7, more preferably less than or equal to 6, and further preferably less than or equal to 5. TI can be measured by a method described in Examples.

A density difference occurring after the MR fluid is prepared is preferably smaller and is preferably less than or equal to ±20%, more preferably less than or equal to ±15%, and further preferably less than or equal to ±10%, for example. The density difference can be measured by a method described in Examples.

A sedimentation proportion is preferably higher and is preferably greater than or equal to 65%, more preferably greater than or equal to 70%, and further preferably greater than or equal to 80%, for example. The sedimentation proportion can be measured by a method described in Examples.

In view of ensuring basic characteristics as an MR fluid, the base viscosity is preferably lower and is preferably less than or equal to 0.1, more preferably less than or equal to 0.05, and further preferably less than or equal to 0.01, for example. An MR effect is preferably greater than or equal to 10, more preferably greater than or equal to 15, and further preferably greater than or equal to 20, for example. The base viscosity and the MR effect can be measured by methods described in Examples.

The MR fluid of the present embodiment is high in the uniformity of concentration distribution. Even when the MR fluid in the storage container is separately supplied to a plurality of devices, the MR fluid can reduce variations in the particle density of the MR fluid supplied to the devices. Consequently, variations in characteristics from device to device can be reduced.

The MR fluid of the present embodiment may be applied to various devices such as clutches, brakes, shock absorbers, and hydraulic dampers. The MR fluid of the present embodiment may be applied to, for example, a clutch as illustrated in FIG. 2. The clutch includes an input shaft 101, an output shaft 102, and an electromagnet 103 surrounding the input and output shafts 101 and 102 and serving as a magnetic field generator. An outer cylinder 111 is fixed to an end of the input shaft 101, and a rotor 121 is fixed to an end of the output shaft 102. The outer cylinder 111 surrounds the rotor 121 such that the outer cylinder 111 and the rotor 121 are disposed to rotate relative to each other. An oil seal 104 is provided to seal the space inside the outer cylinder 111. A gap is present between the outer cylinder 111 and the rotor 121, and upon rotation, is filled with an MR fluid 105 by a centrifugal force. When the electromagnet 103 generates a magnetic field, magnetic particles in the MR fluid form clusters along the lines of magnetic flux, and a torque is transmitted between the outer cylinder 111 and the rotor 121 through the clusters.

The following describes the characteristics of the MR fluid in more detail with reference to examples.

### EXAMPLES

<First Particles>

As the first particles, commercially available carbonyl iron powder (produced by New Metals and Chemicals Corporation, Ltd., UN3189: average particle size 6 μm) having an oxide film on its surface was used.

<Second Particles>

As the second particles, commercially available magnetite particles (produced by Mitsui Mining & Smelting Co., Ltd., sample product) or iron nanoparticles produced as described below were used. The average particle size of the magnetite particles and the average particle size of the iron nanoparticles measured by a Brunauer-Emmett-Teller (BET) technique were 150 nm and 120 nm, respectively.

—Method for Manufacturing Iron Nanoparticles—

First, a container 13 of an apparatus A illustrated in FIG. 2 was filled with a gas mixture of hydrogen and argon to make it atmospheric pressure. The partial pressures of hydrogen and argon were both 0.5 atm. A current of 150 A at 40 V was supplied to between a plasma torch 11 (a cathode) made of tungsten and a metal material 21 (an anode) placed on a water-cooled copper hearth 12 by a direct-current power supply 14 to generate arc plasma 18. As the metal material 21, pure iron (with a purity of 99.98%, produced by Sigma-Aldrich Co. LLC) was used. The generation rate of iron particles was about 0.8 g/min.

The generated iron particles were sucked by a gas circulating pump 15, and collected by a particle collector 16 coupled to the container 13. After this, a dry air (nitrogen 80%, oxygen 20%) atmosphere containing 5% of argon was created in the container 13 and the particle collector 16, and the generated iron particles were left untreated for three hours. In this manner, an oxide film with a thickness of about 2 nm to 10 nm was formed on the surfaces of the iron particles. The formation of the oxide film was observed with a transmission electron microscope (TEM). After the three-hour leaving, the thickness of the oxide film hardly changed.

The iron particles provided with the oxide film were taken out of the system A, and left untreated for one hour in the air at an ordinary temperature, thereby introducing a hydroxy group into the surfaces of the iron particles. The iron particles with surfaces into which the hydroxy group has been introduced and a silane coupling agent were placed in a pressure vessel, and the pressure vessel was hermetically sealed. The silane coupling agent was methyltrimethoxysilane (Shin-Etsu Chemical Co., Ltd., KBM-13). The silane coupling agent was placed in an open container such as a beaker such that the iron particles and the silane coupling agent were not directly mixed together. The weight of the silane coupling agent was 0.38 g per 10 g of the iron particles. The pressure vessel containing the iron particles and the silane coupling agent was left untreated for two hours in a drying furnace at 80° C. such that the silane coupling agent was vaporized in the pressure vessel. The vaporized silane coupling agent reacted with the hydroxy group on the surfaces of the iron particles, thereby obtaining second particles made of iron particles whose surfaces were provided with a surface modified layer.

After the formation of the surface modified layer, the second magnetic particles were dispersed in toluene, and deagglomerated using a ball mill for six hours. A zirconia pod having a capacity of 1 L was used as the pod of the ball mill, and zirconia balls each having a diameter of 1 mm were used as balls.

The coercive force of the obtained second magnetic particles was 175 Oe. For the measurement of the coercive force, a vibrating sample magnetometer (VSM) was used.

<Third Particles>

As the third particles, commercially available magnetite particles (produced by Mitsui Mining & Smelting Co., Ltd., sample product) were used. The average particle size thereof measured by a BET technique was 30 nm.

<Preparation of MR Fluid>

The first particles, the second particles, and the third particles were dispersed in a dispersion medium at a predetermined ratio, thereby obtaining MR fluids. The dispersion medium was silicone oil (Shin-Etsu Chemical Co., Ltd., KF-96-50cs). Predetermined amounts of the first particles, the second particles, the third particles, and the dispersion medium were mixed in a container with hands using a spatula, and then subjected to high shear mixing with a planetary centrifugal mixer (manufactured by KURABO INDUSTRIES LTD., MAZERUSTAR), thereby dispersing the magnetic particles in the dispersion medium. The concentration of a fine particle mixture with the first particles, the second particles, and the third particles mixed together in the dispersion medium was about 25 vol %.

<Measurement of Sedimentation Proportion>

About 20 mL of an MR fluid was placed in a container and allowed to stand for one week. Then, the total height and the height of a particle sedimentation layer were measured, and a sedimentation proportion was calculated using the following equation:

Sedimentation proportion (%)=(total height−height of particle sedimentation layer)/total height×100

As the sedimentation proportion increases, the degree of sedimentation of the magnetic particles decreases, and an MR fluid becomes more stable.

<Measurement of Density Difference>

The density difference occurring after the MR fluids were prepared was determined by the following equation:

Density difference (%)={initial density (g/mL)−density after being allowed to stand (g/mL)}/initial density (g/mL)×100

The initial density was calculated from each particle density and solvent density. The density after being allowed to stand was measured using a specific gravity bottle (manufactured by Thermo Fisher Scientific K. K., specific gravity bottle (pycnometer), capacity 11.5 mL) after the sample was allowed to stand for one week.

First, a mass (M1) of an empty specific gravity cup was measured. Next, an MR fluid placed in a container was stirred using a stainless spatula for ten seconds, and then the MR fluid was moved from the container to the specific gravity cup to fill the specific gravity cup. The specific gravity cup filled with the MR fluid was set to a test temperature (25° C.), and then air bubbles were removed therefrom. After this, the specific gravity cup was lidded, and the MR fluid overflowed from an overflow orifice was removed. Subsequently, a mass (M2) of the specific gravity cup filled with the MR fluid was determined, and the density was determined by the following equation:

Density (g/mL)=(M2 (g)−M1 (g))/volume of specific gravity cup (mL)

<Measurement of Base Viscosity>

The measurement of the base viscosity was performed using a parallel plate type rotational viscometer. The spacing between the plates was 500 μm, and parallel plates with a diameter of 20 mm were used. A shearing stress when a shearing speed was kept constant at 1 s⁻¹ for 30 seconds was measured.

<Measurement of MR Effect>

The measurement of the MR effect was performed on the same conditions as those for the base viscosity with a magnetic field uniformly applied to a measured part.

<Measurement of Dynamic Range>

A dynamic range was determined by performing calculation by the following equation from the measured values of the base viscosity and the MR effect:

Dynamic range=MR effect (kPa)/base viscosity (kPa)

<Measurement of Thixotropic Properties>

A viscosity (Ma) when the number of revolutions was 3 rpm and a viscosity (ib) when the number of revolutions was 30 rpm were measured, and a thixotropic index (TI) was calculated by the following equation. The viscosity was measured using a parallel plate type rotational viscometer with 20 mm diameter parallel plates set.

TI=ηb/ηa

<Overall Rating>

An example showing greater than or equal to respective standard values for the density difference, the TI, and the MR effect and a relatively favorable value for the base viscosity was rated 4; an example showing greater than or equal to respective standard values for all the items was rated 3; an example showing greater than or equal to the respective standard values for the density difference and the TI and values less than or equal to the respective standard values for the base viscosity and the MR effect was rated 2; and an example showing a value less than or equal to the standard value for any one of the density difference or the TI was rated 1.

### Example 1

The amounts of the first particles, the second particles, and the third particles were 39.56 g, 0.4 g, and 0.04 g, respectively. For the second particles, magnetite particles having an average particle size of 150 nm were used. The total mass of the fine particle mixture was 40 g in which the proportions of the first particles, the second particles, and the third particles in the fine particle mixture were 98.9 mass %, 1.0 mass %, and 0.1 mass %, respectively. The mass ratio m₃/m₂ of the third particles to the second particles was 0.1. The mass of the dispersion medium was 14.68 g. The proportion of the fine particle mixture in the MR fluid was 25.0 vol %.

The MR fluid of Example 1 showed a sedimentation proportion of 69.9%, a density difference of 10.4%, a base viscosity of 0.006 kPa, an MR effect of 23.6 kPa, a dynamic range of 3,930 times, a TI of 3.4, and an overall rating of 2.

### Example 2

The amounts of the first particles, the second particles, and the third particles were 38.8 g, 0.4 g, and 0.8 g, respectively. For the second particles, Fe particles having an average particle size of 120 nm were used. The total mass of the fine particle mixture was 40 g in which the proportions of the first particles, the second particles, and the third particles in the fine particle mixture were 97.0 mass %, 1.0 mass %, and 2.0 mass %, respectively. The mass ratio m₃/m₂ of the third particles to the second particles was 2.0. The mass of the dispersion medium was 14.90 g. The proportion of the fine particle mixture in the MR fluid was 25.0 vol %.

The MR fluid of Example 2 showed a sedimentation proportion of 76.4%, a density difference of 13.1%, a base viscosity of 0.007 kPa, an MR effect of 23.3 kPa, a dynamic range of 3,330 times, a TI of 3.4, and an overall rating of 2.

### Example 3

The amounts of the first particles, the second particles, and the third particles were 38.0 g, 0.4 g, and 1.6 g, respectively. For the second particles, magnetite particles having an average particle size of 150 nm were used. The total mass of the fine particle mixture was 40 g in which the proportions of the first particles, the second particles, and the third particles in the fine particle mixture were 95.0 mass %, 1.0 mass %, and 4.0 mass %, respectively. The mass ratio m₃/m₂ of the third particles to the second particles was 4.0. The mass of the dispersion medium was 15.05 g. The proportion of the fine particle mixture in the MR fluid was 25.0 vol %.

The MR fluid of Example 3 showed a sedimentation proportion of 80.7%, a density difference of 9.0%, a base viscosity of 0.008 kPa, an MR effect of 21.8 kPa, a dynamic range of 2,730 times, a TI of 3.7, and an overall rating of 2.

### Example 4

The amounts of the first particles, the second particles, and the third particles were 37.2 g, 0.4 g, and 2.4 g, respectively. For the second particles, magnetite particles having an average particle size of 150 nm were used. The total mass of the fine particle mixture was 40 g in which the proportions of the first particles, the second particles, and the third particles in the fine particle mixture were 93.0 mass %, 1.0 mass %, and 6.0 mass %, respectively. The mass ratio m₃/m₂ of the third particles to the second particles was 6.0. The mass of the dispersion medium was 15.20 g. The proportion of the fine particle mixture in the MR fluid was 25.0 vol %.

The MR fluid of Example 4 showed a sedimentation proportion of 79.6%, a density difference of 5.2%, a base viscosity of 0.008 kPa, an MR effect of 20.4 kPa, a dynamic range of 2,550 times, a TI of 3.8, and an overall rating of 2.

### Example 5

The amounts of the first particles, the second particles, and the third particles were 36.4 g, 0.4 g, and 3.2 g, respectively. For the second particles, magnetite particles having an average particle size of 150 nm were used. The total mass of the fine particle mixture was 40 g in which the proportions of the first particles, the second particles, and the third particles in the fine particle mixture were 91.0 mass %, 1.0 mass %, and 8.0 mass %, respectively. The mass ratio m₃/m₂ of the third particles to the second particles was 8.0. The mass of the dispersion medium was 15.42 g. The proportion of the fine particle mixture in the MR fluid was 24.9 vol %.

The MR fluid of Example 5 showed a sedimentation proportion of 82.7%, a density difference of 5.0%, a base viscosity of 0.009 kPa, an MR effect of 20.0 kPa, a dynamic range of 2,220 times, a TI of 3.9, and an overall rating of 4.

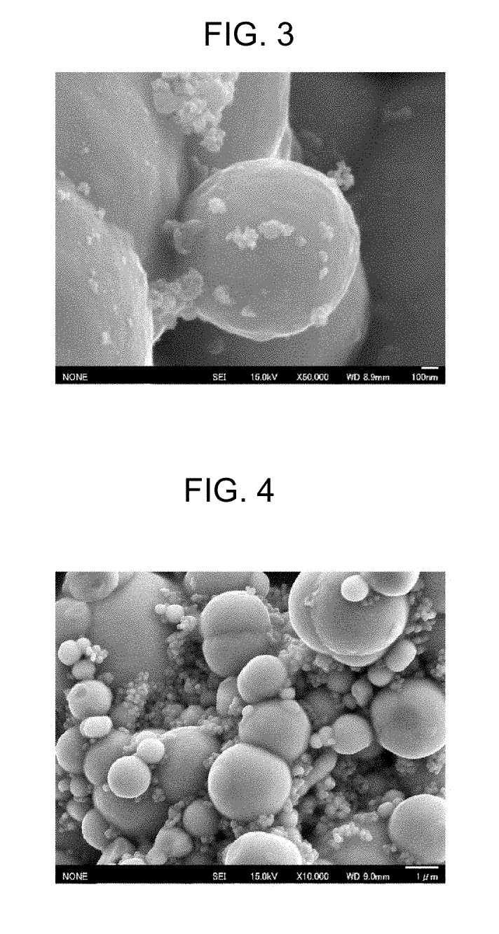

FIG. 3 shows a result obtained by observing the MR fluid of Example 5 with a scanning electron microscope (manufactured by JEOL Ltd.: JSM-7000F). The second particles and the third particles adhere to the surfaces of the first particles. It is considered from this result that the second particles and the third particles enter gaps between the first particles and are uniformly dispersed in the dispersion medium.

### Example 6

The amounts of the first particles, the second particles, and the third particles were 36.0 g, 0.4 g, and 3.6 g, respectively. For the second particles, magnetite particles having an average particle size of 150 nm were used. The total mass of the fine particle mixture was 40 g in which the proportions of the first particles, the second particles, and the third particles in the fine particle mixture were 90.0 mass %, 1.0 mass %, and 9.0 mass %, respectively. The mass ratio m₃/m₂ of the third particles to the second particles was 9.0. The mass of the dispersion medium was 15.42 g. The proportion of the fine particle mixture in the MR fluid was 25.0 vol %.

The MR fluid of Example 6 showed a sedimentation proportion of 89.1%, a density difference of 3.6%, a base viscosity of 0.01 kPa, an MR effect of 20.2 kPa, a dynamic range of 2,020 times, a TI of 4.0, and an overall rating of 4.

### Example 7

The amounts of the first particles, the second particles, and the third particles were 30.4 g, 8.0 g, and 1.6 g, respectively. For the second particles, magnetite particles having an average particle size of 150 nm were used. The total mass of the fine particle mixture was 40 g in which the proportions of the first particles, the second particles, and the third particles in the fine particle mixture were 76.0 mass %, 20.0 mass %, and 4.0 mass %, respectively. The mass ratio m₃/m₂ of the third particles to the second particles was 0.2. The mass of the dispersion medium was 16.47 g. The proportion of the fine particle mixture in the MR fluid was 25.0 vol %.

The MR fluid of Example 7 showed a sedimentation proportion of 97.8%, a density difference of 0.8%, a base viscosity of 0.08 kPa, an MR effect of 12.4 kPa, a dynamic range of 155 times, a TI of 6.8, and an overall rating of 3.

### Comparative Example 1

The amounts of the first particles and the second particles were 39.6 g and 0.4 g, respectively, with no third particles added. For the second particles, magnetite particles having an average particle size of 150 nm were used. The total mass of the fine particle mixture was 40 g in which the proportions of the first particles and the second particles in the fine particle mixture were 99.0 mass % and 1.0 mass %, respectively. The mass of the dispersion medium was 14.75 g. The proportion of the fine particle mixture in the MR fluid was 25.0 vol %.

The MR fluid of Comparative Example 1 showed a sedimentation proportion of 69.8%, a density difference of 24.8%, a base viscosity of 0.007 kPa, an MR effect of 7.6 kPa, a dynamic range of 1,090 times, a TI of 1.65, and an overall rating of 1.

FIG. 4 shows an electron micrograph of the MR fluid of Comparative Example 1. Although the second particles enter gaps between the first particles, the third particles, which are further smaller, are not observed.

Table 1 collectively lists the configurations and characteristics of the MR fluids of the respective examples and comparative example.

TABLE 1

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| First Particles | Amount (g) | 39.56 | 38.8 | 38.0 | 37.2 | 36.4 | 36.0 | 30.4 | 39.6 |
| (6 μm) | Proportion (mass %) | 98.9 | 97.0 | 95.0 | 93.0 | 91.0 | 90.0 | 76.0 | 99.0 |
| Second Particles | Amount (g) | 0.4 | — | 0.4 | 0.4 | 0.4 | 0.4 | 8.0 | 0.4 |
| (150 nm) | Proportion (mass %) | 1.0 | — | 1.0 | 1.0 | 1.0 | 1.0 | 20.0 | 1.0 |
| Second Particles | Amount (g) | — | 0.4 | — | — | — | — | — | — |
| (120 nm) | Proportion (mass %) | — | 1.0 | — | — | — | — | — | — |
| Third particles | Amount (g) | 0.04 | 0.8 | 1.6 | 2.4 | 3.2 | 3.6 | 1.6 | 0 |
| (30 nm) | Proportion (mass %) | 0.1 | 2.0 | 4.0 | 6.0 | 8.0 | 9.0 | 4.0 | 0 |

| | | | | | | | | |
|---|---|---|---|---|---|---|---|---|
| m₃/m₂ | 0.1 | 2.0 | 4.0 | 6.0 | 8.0 | 9.0 | 0.2 | 0 |
| Fine Particle Mixture Amount (g) | 40.0 | 40.0 | 40.0 | 40.0 | 40.0 | 40.0 | 40.0 | 40.0 |
| Dispersion Medium Amount (g) | 14.68 | 14.90 | 15.05 | 15.20 | 15.42 | 15.42 | 16.47 | 14.75 |
| Concentration (vol %) | 25.0 | 25.0 | 25.0 | 25.0 | 24.9 | 25.0 | 25.0 | 25.0 |
| Sedimentation Proportion (%) | 69.9 | 76.4 | 80.7 | 79.6 | 82.7 | 89.1 | 97.8 | 69.8 |
| Density Difference (%) | 10.4 | 13.1 | 9.0 | 5.2 | 5.0 | 3.6 | 0.8 | 24.8 |
| Base Viscosity (kPa) | 0.006 | 0.007 | 0.008 | 0.008 | 0.009 | 0.01 | 0.08 | 0.007 |
| MR Effect (kPa) | 23.6 | 23.3 | 21.8 | 20.4 | 20.0 | 20.2 | 12.4 | 7.6 |
| Dynamic Range | 3930 | 3330 | 2730 | 2550 | 2220 | 2020 | 155 | 1090 |
| TI | 3.4 | 3.4 | 3.7 | 3.8 | 3.9 | 4.0 | 6.8 | 1.7 |
| Overall Rating | 2 | 2 | 2 | 2 | 4 | 4 | 3 | 1 |

### INDUSTRIAL APPLICABILITY

The MR fluid of the present disclosure is high in the uniformity of concentration distribution, is easily supplied to devices, and is thus useful as an MR fluid.

### DESCRIPTION OF REFERENCE CHARACTERS

11 Plasma Torch
12 Water-Cooled Copper Hearth
13 Container
14 Direct-Current Power Supply
15 Gas Circulating Pump
16 Particle Collector
18 Arc Plasma
21 Metal Material
101 Input Shaft
102 Output Shaft
103 Electromagnet
104 Oil Seal
105 MR Fluid
111 Outer Cylinder
121 Rotor

1. A magnetorheological fluid comprising:
a fine particle mixture; and
a dispersion medium in which the fine particle mixture is dispersed,
wherein
the fine particle mixture includes first particles, second particles, and third particles,
the first particles are magnetic particles having an average particle size greater than or equal to 1 μm and less than or equal to 30 μm,
the second particles are magnetic particles having an average particle size greater than or equal to 100 nm and less than or equal to 300 nm,
the third particles are particles having an average particle size greater than or equal to 10 nm and less than or equal to 50 nm, and
a proportion of the first particles in the fine particle mixture is greater than or equal to 60 mass % and less than 99 mass %, the remainder being the second particles and the third particles.

2. The magnetorheological fluid of claim 1, wherein
a mass ratio of the third particles to the second particles is greater than or equal to 0.1 and less than or equal to 10.

3. The magnetorheological fluid of claim 1, wherein
the third particles are magnetite particles.

4. The magnetorheological fluid of claim 1, wherein
at least one of the first particles, the second particles, or the third particles have a surface modified layer provided on surfaces thereof, and
a surface of the surface modified layer is more hydrophobic than the surfaces of the at least one of the first particles, the second particles, or the third particles on which the surface modified layer is provided.

5. The magnetorheological fluid of claim 1, wherein
at least one of the first particles, the second particles, or the third particles have a surface modified layer provided on surfaces thereof, and
a surface of the surface modified layer is more hydrophilic than the surfaces of the at least one of the first particles, the second particles, or the third particles on which the surface modified layer is provided.
